(19) United States
(12) Patent Application Publication
(10) Pub. No.: US 2017/0057296 A1
(43) Pub. Date: Mar. 2, 2017

(54) Pneumatic Tire

(71) Applicant: The Yokohama Rubber Co., LTD., Minato-ku, Tokyo (JP)

(72) Inventor: Ryohei Takemori, Hiratsuka-shi, Kanagawa (JP)

(21) Appl. No.: 15/308,340

(22) PCT Filed: Apr. 14, 2015
(86) PCT No.: PCT/JP2015/061499

§ 371 Date: Nov. 1, 2016

(30) Foreign Application Priority Data
May 1, 2014 (JP) 2014-094449

(51) Int. Cl. B60C 11/03; B60C 11/12

(52) U.S. Cl. CPC B60C 11/032; B60C 11/1218; B60C 11/0304; B60C 11/0306; B60C 11/1236; B60C 11/1263; B60C 2011/0341; B60C 2011/0358

(57) ABSTRACT

This pneumatic tire is provided with: a circumferential main groove (22) extending in a tire circumferential direction, a shoulder land portion (33) defined by the circumferential main groove (22), and a plurality of lug grooves (43) disposed in the shoulder land portion (33). Additionally, the shoulder land portion (33) is provided with a dimple (6) for mud discharge that is disposed between lug grooves (43, 43) adjacent in the tire circumferential direction and extends in a tire width direction without communicating to a lug groove (43). Additionally, a distance Dd between an end portion of the dimple (6) on a tire-width-direction inner side and a tire ground contact edge (T) is in a range of −10 mm≦Dd≦10 mm.

### TECHNICAL FIELD

This technology relates to a pneumatic tire and particularly relates to a pneumatic tire capable of improved off-road performance.

### BACKGROUND ART

With conventional pneumatic tires mounted to a recreational vehicle (RV), there is a problem of improving an off-road performance (such as a mud performance and a snow performance). Note that as a conventional pneumatic tire having an off-road performance, the technology described in Japanese Patent No. 4048058B is known.

### SUMMARY

This technology provides a pneumatic tire capable of improved off-road performance.

A pneumatic tire according to this technology is a pneumatic tire, provided with: a plurality of circumferential main grooves extending in a tire circumferential direction, a plurality of land portions defined by the circumferential main grooves, and a plurality of lug grooves disposed in the land portions. In such a pneumatic tire, when an outermost land portion in a tire width direction of the land portions is referred to as a shoulder land portion, the shoulder land portion is provided with a dimple for mud discharge that is disposed between lug grooves adjacent in the tire circumferential direction and extends in the tire width direction without communicating to a lug groove, and a distance Dd between an end portion of the dimple on a tire-width-direction inner side and a tire ground contact edge is in a range of −10 mm≦Dd≦10 mm.

With the pneumatic tire according to this technology, when traveling on a muddy road, mud is discharged sideways of the tire via the dimple from a tread surface of the shoulder land portion. By this, there is an advantage where a mud performance of the tire improves. Additionally, by the distance Dd of the end portion of the dimple on the tire-width-direction inner side being disposed near a tire ground contact edge T, there is an advantage where the mud performance of the tire improves even more.

### BRIEF DESCRIPTION OF DRAWING

FIG. 1 is a cross-sectional view along a tire meridian direction illustrating a pneumatic tire according to an embodiment of the technology.

FIG. 2 is a plan view illustrating a tread surface of the pneumatic tire illustrated in FIG. 1.

FIG. 3 is a tread development view illustrating a shoulder land portion of the pneumatic tire illustrated in FIG. 2.

FIG. 4 is a cross-sectional view illustrating the shoulder land portion illustrated in FIG. 3.

FIG. 5 is an enlarged view illustrating a three-dimensional sipe illustrated in FIG. 4.

FIG. 6 is an explanatory view illustrating an example of a three-dimensional sipe.

FIG. 7 is an explanatory view illustrating an example of a three-dimensional sipe.

FIG. 8 is an explanatory diagram illustrating a modified example of the pneumatic tire illustrated in FIG. 1.

FIG. 9 is an explanatory diagram illustrating a modified example of the pneumatic tire illustrated in FIG. 1.

FIG. 10 is a table showing results of performance testing of the pneumatic tire according to the embodiments of the technology.

### DETAILED DESCRIPTION

The technology is described in detail below with reference to the accompanying drawings. However, the technology is not limited to the embodiments. In addition, the components of the embodiments include components that are replaceable while maintaining consistency with the technology, and obviously replaceable components. Furthermore, a plurality of modified examples described in the embodiments may be freely combined within the scope of obviousness to a person skilled in the art.

Pneumatic Tire

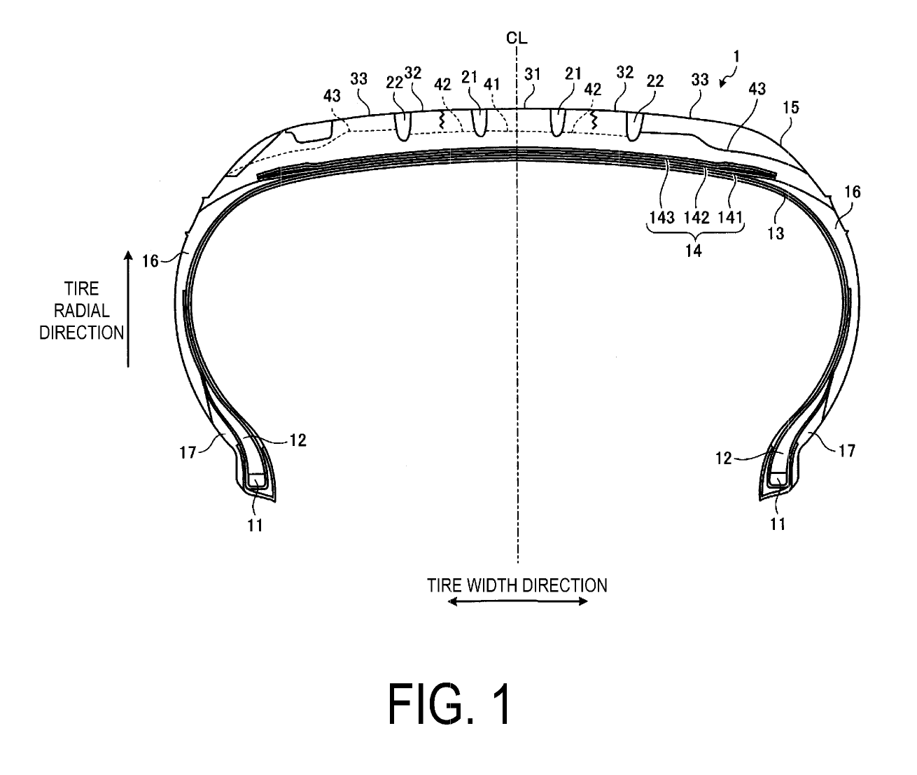

FIG. 1 is a cross-sectional view along a tire meridian direction illustrating a pneumatic tire according to an embodiment of the technology. The diagram illustrates a cross-sectional view of a region on one side in a tire radial direction. Also, FIG. 1 illustrates a radial tire for a passenger vehicle as an example of a pneumatic tire.

In the diagram, a cross section in the tire meridian direction refers to a cross section where the tire is cut at a plane including a tire rotation axis (not illustrated). The reference sign “CL” denotes the tire equatorial plane and refers to a plane normal to the tire rotation axis that passes through the center point of the tire in the tire rotation axis direction. The term “tire width direction” refers to a direction parallel to the tire rotation axis. The term “tire radial direction” refers to a direction normal to the tire rotation axis.

The pneumatic tire 1 has an annular structure centered on the tire rotational axis and includes a pair of bead cores 11, 11, a pair of bead fillers 12, 12, a carcass layer 13, a belt layer 14, a tread rubber 15, a pair of sidewall rubbers 16, 16, and a pair of rim cushion rubbers 17, 17 (see FIG. 1).

The pair of bead cores 11, 11 are annular members constituted by a plurality of bead wires bundled together. The pair of bead cores 11, 11 constitute the cores of the left and right bead portions. The pair of bead fillers 12, 12 are disposed on peripheries of the pair of bead cores 11, 11 in the tire radial direction and constitute the bead portions.

The carcass layer 13 extends between the left and right bead cores 11, 11 in a toroidal form, forming a framework for the tire. Additionally, both ends of the carcass layer 13 are folded toward outer sides in the tire width direction so as to wrap around the bead cores 11 and the bead fillers 12, and fixed. The carcass layer 13 is constituted by a plurality of carcass cords formed from steel or organic fibers (e.g. aramid, nylon, polyester, rayon, or the like) covered by a coating rubber and subjected to a rolling process, and has a carcass angle (inclination angle of the fiber direction of the carcass cords with respect to the tire circumferential direction), as an absolute value, from 80 to 95 degrees, both inclusive.

The belt layer 14 is formed by layering a pair of cross belts 141, 142, and a belt cover 143. The belt layer 14 is disposed on the periphery of the carcass layer 13. The pair of cross belts 141, 142 are constituted by a plurality of belt cords formed from steel or organic fibers, covered by coating rubber, and subjected to a rolling process, having a belt angle, as an absolute value, from 20 degrees to 55 degrees, both inclusive. Furthermore, the pair of cross belts 141 and 142 have belt angles (inclination angle in the fiber direction of the belt cord with respect to the tire circumferential direction) of opposite signs, and the belts are layered so as to intersect each other in the belt cord fiber directions (crossply configuration). The belt cover 143 is configured by a plurality of cords formed from steel or an organic fiber material, covered by coating rubber, and subjected to a rolling process, having a belt angle, as an absolute value, from 0 to 10 degrees, both inclusive. Moreover, the belt cover 143 is disposed so as to be layered outward of the cross belts 141, 142 in the tire radial direction.

The tread rubber 15 is disposed on the outer circumference of the carcass layer 13 and the belt layer 14 in the tire radial direction, and constitutes a tread portion. The pair of the sidewall rubbers 16, 16 are disposed outward of the carcass layer 13 in the tire width direction. The sidewall rubbers 16, 16 constitute sidewall portions on the left and right sides. The pair of rim cushion rubbers 17, 17 are disposed inward of the left and right bead cores 11, 11 and the folded back portion of the carcass layer 13 in the tire radial direction. The pair of rim cushion rubbers 17, 17 constitute the contact surfaces of the left and right bead portions with the rim flanges.

Tread Pattern

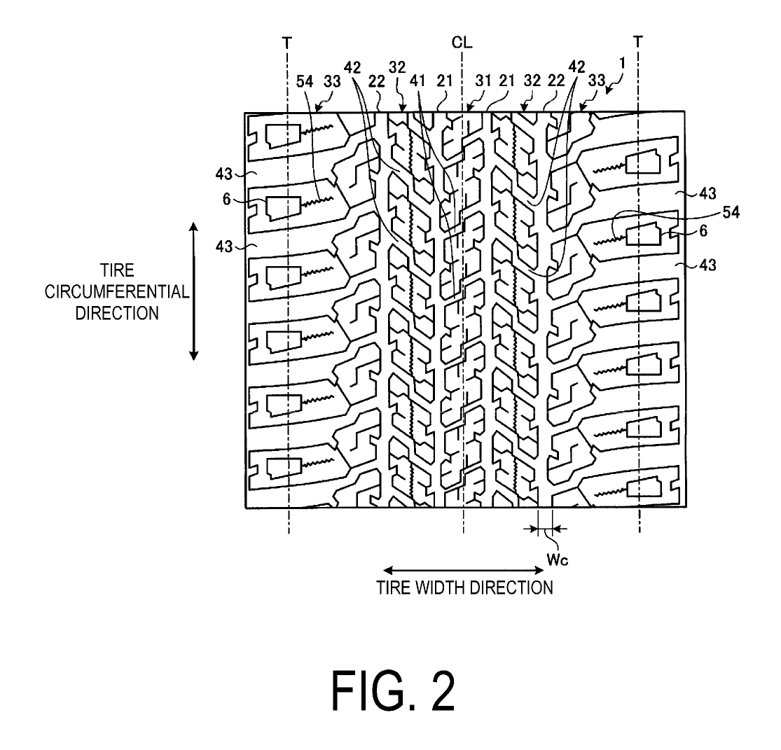

FIG. 2 is a plan view illustrating a tread surface of the pneumatic tire illustrated in FIG. 1. The diagram illustrates a tread pattern of a winter tire mounted to a recreational vehicle (RV) or the like. In the diagram, “tire circumferential direction” refers to a direction around the tire rotation axis. Additionally, the reference sign T is a tire ground contact edge.

This pneumatic tire 1 is provided with, in the tread portion, a plurality of circumferential main grooves 21, 22 extending in the tire circumferential direction; a plurality of land portions 31 to 33 defined by these circumferential main grooves 21, 22; and a plurality of lug grooves 41 to 43 disposed in these land portions 31 to 33 (see FIG. 2).

A circumferential main groove is a circumferential groove having a wear indicator indicating a wear end stage and generally has a groove width of 5.0 mm or greater and a groove depth of 7.5 mm or greater. Additionally, “lug groove” refers to a horizontal groove having a groove width of 3.0 mm or greater and a groove depth of 4.0 mm or greater. Additionally, “sipe”, which will be described hereinafter, refers to a cut formed in a land portion, typically with a sipe width of less than 1.0 mm.

A groove width is measured as a maximum value of a distance between left and right groove walls in a groove opening portion in an unloaded state where the tire is mounted to a specified rim and filled to a specified internal pressure. In a configuration where the land portion has a notched portion or a chamfered portion in an edge portion, the groove width is measured with an intersection between the tread surface and an extension line of the groove wall as a reference in a cross-sectional view where a groove length direction is a normal line direction. Additionally, in a configuration where a groove extends in the tire circumferential direction in a zigzag form or a wave shape, the groove width is measured with a center line of an amplitude of the groove wall as a reference.

A groove depth is measured as a maximum value of a distance from the tread surface to a groove bottom in the unloaded state where the tire is mounted to the specified rim and filled to the specified internal pressure. Additionally, in a configuration where the groove has a partial uneven portion or a sipe in the groove bottom, the groove depth is measured with these excluded.

Herein, the term “specified rim” refers to an applicable rim as defined by the Japan Automobile Tyre Manufacturers Association (JATMA), a design rim as defined by the Tire and Rim Association (TRA), or a measuring rim defined by the European Tyre and Rim Technical Organization (ETRTO). “Specified internal pressure” refers to “maximum air pressure” stipulated by JATMA, a maximum value in “tire load limits at various cold inflation pressures” defined by TRA, and “inflation pressures” stipulated by ETRTO.

Additionally, “specified load” refers to “maximum load capacity” defined by JATMA, a maximum value in “tire load limits at various cold inflation pressures” defined by TRA, and “load capacity” defined by ETRTO. However, according to JATMA, for a passenger vehicle tire, the specified internal pressure is an air pressure of 180 kPa, and a specified load is 88% of maximum load capacity.

For example, in the configuration of FIG. 2, four circumferential main grooves 21, 22 having a straight shape are disposed to be laterally symmetrical across the tire equatorial plane CL. In this manner, a configuration where the plurality of circumferential main grooves 21, 22 is disposed to be laterally symmetrical with the tire equatorial plane CL as a boundary is preferable in that wear modes of left and right regions whose boundary is the tire equatorial plane CL are made uniform and a wear life of the tire improves.

However, the present technology is not limited thereto, and the circumferential main grooves may be disposed to be laterally asymmetrical across the tire equatorial plane CL (not illustrated). Additionally, a circumferential main groove may be disposed on the tire equatorial plane CL (not illustrated). Additionally, the circumferential main grooves may have a zigzag form or a wave shape that extends in the tire circumferential direction while bending or curving, and three or five or greater circumferential main grooves may be disposed (not illustrated).

Additionally, in the configuration of FIG. 2, five columns of land portions 31 to 33 are defined by the four circumferential main grooves 21, 22.

Here, left and right circumferential main grooves 22, 22 on an outermost side in the tire width direction are referred to as an outermost circumferential main groove. Additionally, a tread portion center region and a tread portion shoulder region are defined with the left and right outermost circumferential main grooves 22, 22 as a boundary.

Additionally, of the five columns of land portions 31 to 33, the land portion 31 in a center is referred to as a center land portion. Additionally, left and right land portions 32, 32 on a tire-width-direction inner side defined by the outermost circumferential main grooves 22, 22 are referred to as a second land portion. Additionally, left and right land portions 33, 33 on the outermost side in the tire width direction are referred to as a shoulder land portion. The left and right shoulder land portions 33, 33 are respectively disposed on left and right tire ground contact edges T, T.

Note that in the configuration of FIG. 2, the center land portion 31 is disposed on the tire equatorial plane CL. In contrast thereto, in a configuration where a circumferential main groove is disposed on the tire equatorial plane CL (not illustrated), left and right land portions formed by being defined by this circumferential main groove become the center land portion.

Additionally, in the configuration of FIG. 2, all land portions 31 to 33 respectively have the plurality of lug grooves 41 to 43, which extend in the tire width direction. Additionally, these lug grooves 41 to 43 have an open structure of penetrating the land portions 31 to 33 in the tire width direction and are arranged at predetermined intervals in the tire circumferential direction. By this, all land portions 31 to 33 are divided into a plurality of blocks in the tire circumferential direction by the lug grooves 41 to 43 and become a block column.

Note that the present technology is not limited thereto, and a semi-closed structure may be had where the lug grooves 41 to 43 terminate, at one end portion, in the land portions 31 to 33 (not illustrated). In this situation, the land portions 31 to 33 become a rib that continues in the tire circumferential direction.

Dimple and Three-Dimensional Sipe of Shoulder Land Portion

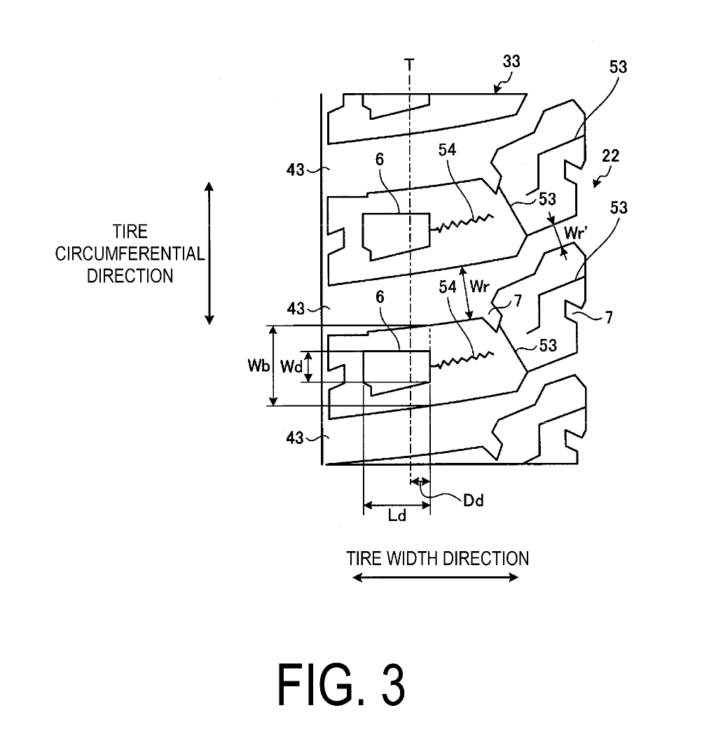

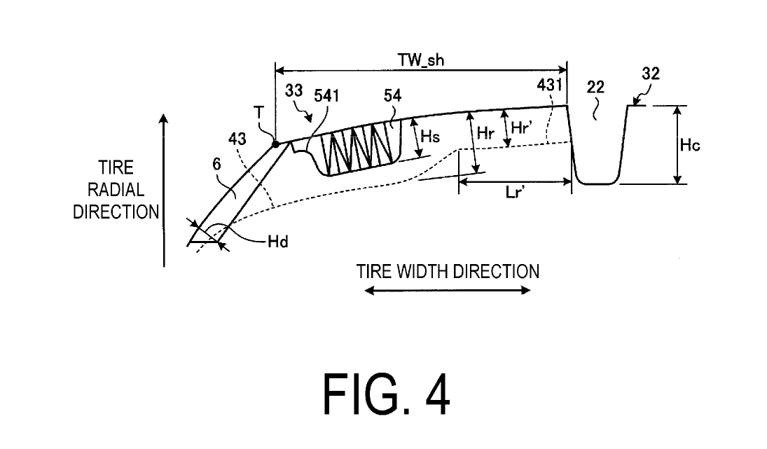

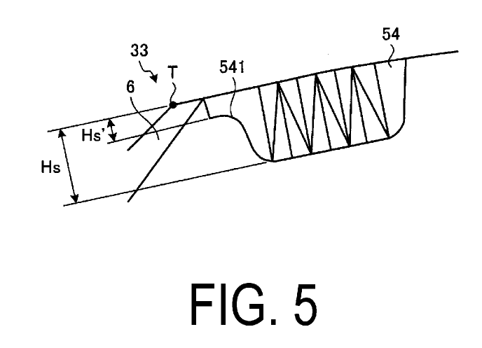

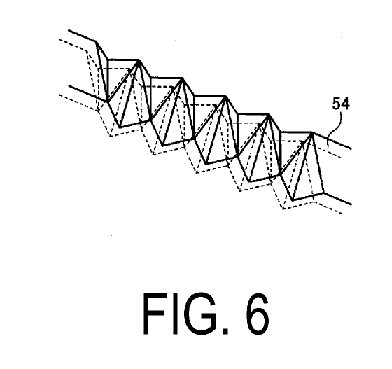

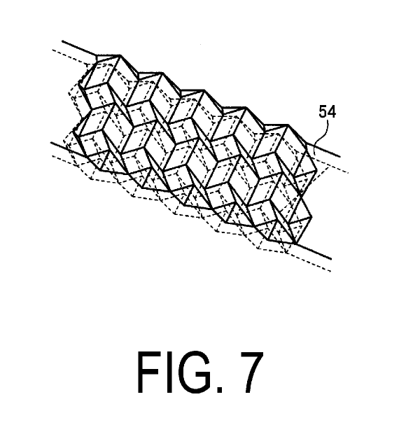

FIG. 3 is a tread development view illustrating the shoulder land portion of the pneumatic tire illustrated in FIG. 2. FIG. 4 is a cross-sectional view illustrating the shoulder land portion illustrated in FIG. 3. The diagram illustrates a cross-sectional view where the shoulder land portion 33 is cut at a plane including a dimple and a three-dimensional sipe. FIG. 5 is an enlarged view illustrating the three-dimensional sipe illustrated in FIG. 4. FIGS. 6 and 7 are explanatory views illustrating examples of the three-dimensional sipe.

With this pneumatic tire 1, the shoulder land portion 33 is provided with a dimple 6 for mud discharge.

The dimple 6 is disposed between lug grooves 43, 43 adjacent in the tire circumferential direction and extends in the tire width direction without communicating to a lug groove 43. Therefore, the dimple 6 is formed inside the shoulder land portion 33, and a continuous land portion section remains between the dimple 6 and forward and rear lug grooves 43, 43. Moreover, an end portion of the dimple 6 on a tire-width-direction outer side is on a tire-width-direction outer side of the tire ground contact edge T.

Additionally, in FIG. 3, a distance Dd between an end portion of the dimple 6 on the tire-width-direction inner side and the tire ground contact edge T is in a range of −10 mm≦Dd≦10 mm. In such a configuration, by the end portion of the dimple 6 on the tire-width-direction inner side being disposed near the tire ground contact edge T (within a range of ±10 mm), a mud performance of the tire improves.

At this time, the end portion of the dimple 6 on the tire-width-direction inner side is preferably on a tire-width-direction inner side of the tire ground contact edge T. Specifically, the distance Dd is preferably in a range of 1.0 mm≦Dd≦10 mm with the tire-width-direction inner side as positive. By this, the mud performance of the tire improves even more.

The “tire ground contact edge T” refers to the maximum width position in a tire axial direction of a contact surface between the tire and a flat plate in a configuration in which the tire is assembled on a specified rim, inflated to a specified internal pressure, placed perpendicular to the flat plate in a static state, and loaded with a load corresponding to a specified load.

The distance Dd is measured with an opening portion of the dimple 6 as a reference in a tread development view.

In the configuration above, when traveling on a muddy road, mud is discharged sideways of the tire via the dimple 6 from a tread surface of the shoulder land portion 33. By this, the mud performance of the tire improves.

Note that in the configuration of FIG. 3, a length Ld of the dimple 6 in the tire width direction is preferably in a range of 20 mm≦Ld. By this, the length Ld of the dimple 6 is optimized, and a mud discharge action by the dimple 6 is appropriately ensured. Note that an upper limit of the length Ld is not particularly limited but is restricted by its relationship with a tread end.

The length Ld is measured with the opening portion of the dimple 6 as a reference in the tread development view.

Additionally, at the end portion of the dimple 6 on the tire-width-direction inner side, a width Wd of the dimple 6 and an interval Wb between the adjacent lug grooves 43, 43 preferably have a relationship where 0.30≦Wd/Wb≦0.55 and more preferably have a relationship where 0.35≦Wd/Wb≦0.50. By this, the width Wd of the dimple 6 is optimized, and the mud discharge action by the dimple 6 is appropriately ensured.

The width Wd of the dimple 6 is measured as an opening width of the dimple 6 in the tire circumferential direction at the end portion of the dimple 6 on the tire-width-direction inner side.

The interval Wb between of the lug grooves 43, 43 corresponds to a width of the shoulder land portion 33 in the tire circumferential direction and is measured at the end portion of the dimple 6 on the tire-width-direction inner side.

Additionally, a surface area Sd of the dimple 6 and a surface area Sb of a region defined by the lug grooves 43 adjacent in the tire circumferential direction preferably have a relationship where 0.10≦Sd/Sb≦0.30.

The surface area Sd of the dimple 6 is measured with the opening portion of the dimple 6 as a reference in the tread development view. The surface area Sb of the region is measured as a surface area of one block of the shoulder land portion 33 in the tread development view. In a situation where the lug groove 43 is a non-penetrating lug groove terminating in the shoulder land portion 33, the surface area Sb of the region is measured as a surface area of a region defined by adjacent lug grooves 43, 43 of when the lug grooves 43 are extended.

Additionally, in FIG. 4, a depth Hd of the dimple 6 is preferably in a range of 1.0 mm≦Hd≦4.0 mm. By this, the depth Hd of the dimple 6 is optimized, and the mud discharge action by the dimple 6 is appropriately ensured.

The depth Hd is measured as a maximum depth of the dimple 6 with an outer surface of the shoulder land portion 33 as a reference.

For example, in the configuration of FIG. 3 and FIG. 4, the dimple 6 has a substantially trapezoidal shape widening from the tire-width-direction inner side to outer side in the tread development view (see FIG. 3). Additionally, the end portion of the dimple 6 on the tire-width-direction inner side is on the tire-width-direction inner side of the tire ground contact edge T, and the end portion on the tire-width-direction outer side is on the tire-width-direction outer side of the tire ground contact edge T. Because of this, the dimple 6 intersects the tire ground contact edge T, exceeds the tire ground contact edge T, and extends in the tire width direction. Additionally, the width Wd of the dimple 6 and the interval Wb between the adjacent lug grooves 43, 43 have the relationship where 0.30≦Wd/Wb≦0.55. Additionally, as illustrated in FIG.

4, the dimple 6 opens to the tread surface (tire ground contact surface) of the shoulder land portion 33 and extends to the tire-width-direction outer side (tire-radial-direction inner side) along a tire profile from the tire ground contact edge T.

Additionally, in the configuration of FIG. 3 and FIG. 4, the shoulder land portion 33 is provided with a plurality of sipes 53 and a plurality of notched portions 7. Specifically, the shoulder land portion 33 is provided with the plurality of blocks divided in the tire circumferential direction by the plurality of lug grooves 43, and these blocks are respectively provided with two two-dimensional sipes (flat sipes) 53 and two notched portions 7. By these two-dimensional sipes 53 and notched portions 7, an edge component of the shoulder land portion 33 is ensured, and a traction of the tire improves.

A two-dimensional sipe is a sipe having a sipe wall surface of a rectilinear shape in a cross-sectional view with a sipe length direction as a normal line direction (cross-sectional view including a sipe width direction and a sipe depth direction). The two-dimensional sipe may have a straight shape in the tread surface or may have a zigzag form, a wave shape, or an arc shape.

Additionally, a first two-dimensional sipe 53 opens, at one end portion, to the outermost circumferential main groove 22; bends and extends in the tire width direction; and terminates, at another end portion, inside the shoulder land portion 33 and in the tire ground contact surface. Additionally, a first notched portion 7 is formed in an edge portion, of the block of the shoulder land portion 33, on a circumferential-main-groove 22 side.

Additionally, a second two-dimensional sipe 53 is disposed in the tire ground contact surface, extends in the tire circumferential direction while inclining at a predetermined angle relative to the tire equatorial plane, and penetrates the block of the shoulder land portion 33 in the tire circumferential direction. Additionally, a second notched portion 7 is formed in an edge portion of the shoulder land portion 33 on a lug-groove 43 side. Additionally, one end portion of the second two-dimensional sipe 53 communicates to this second notched portion 7.

Additionally, in the configuration of FIG. 3 and FIG. 4, the shoulder land portion 33 is provided with one three-dimensional sipe 54.

A three-dimensional sipe is a sipe having a sipe wall surface of a shape bent in a sipe width direction in a cross-sectional view with a sipe length direction as a normal line direction. Compared to the two-dimensional sipes, the three-dimensional sipes have a greater mating force between opposing sipe wall faces and, therefore, act to reinforce rigidity of the land portions. The three-dimensional sipe may have a straight shape in the tread surface or may have a zigzag form, a wave shape, or an arc shape. For example, the following can be mentioned as such a three-dimensional sipe (see FIG. 6 and FIG. 7).

FIGS. 6 and 7 are explanatory views illustrating examples of the three-dimensional sipe. These diagrams illustrate a transparent perspective view of a three-dimensional sipe having a sipe wall surface of a pyramid type. With these three-dimensional sipes, a pair of opposing sipe wall surfaces has a wall surface shape formed by arranging a plurality of pyramids or prisms continuously in the sipe length direction.

With the three-dimensional sipe 54 in FIG. 6, the sipe wall surface has a structure where triangular pyramids and inverted triangular pyramids are linked in the sipe length direction. In other words, the sipe wall face is formed by mutually offsetting pitches of a zigzag form of the tread surface side and a zigzag form of the bottom side in the tire width direction so that mutually opposing protrusions and recesses are formed between the zigzag forms on the tread surface side and the bottom side. Additionally, with these protrusions and recesses, when viewed in a tire rotating direction, the sipe wall face is formed by connecting a protrusion inflection point on the tread surface side to a recess inflection point on the bottom side, a recess inflection point on the tread surface side to a protrusion inflection point on the bottom side, and protrusion inflection points mutually adjacent to the protrusion inflection point on the tread surface side and the protrusion inflection point on the bottom side with ridge lines; and by connecting these ridge lines with consecutive planes in the tire width direction. Additionally, a first sipe wall face has a corrugated surface wherein convex pyramids and inverted pyramids are arranged alternating in the tire width direction; and a second sipe wall face has a corrugated surface wherein concave pyramids and inverted pyramids are arranged alternating in the tire width direction. Furthermore, with the sipe wall face, at least the corrugated surfaces disposed at outermost sides of both ends of the sipe are oriented toward an outer side of the blocks. Note that examples of such a three-dimensional sipe include the technology described in Japanese Patent No. 3894743B.

Additionally, with the three-dimensional sipe 54 in FIG. 7, the sipe wall surface has a structure where a plurality of prisms having a block shape is linked in a sipe depth direction and the sipe length direction while being inclined in the sipe depth direction. In other words, the sipe wall face has a zigzag form in the tread surface. Additionally, the sipe wall face has bent portions in at least two locations in the tire radial direction in the blocks that bend in the tire circumferential direction and are connected in the tire width direction. Moreover, these bent portions have a zigzag form that oscillates in the tire radial direction. Additionally, while, in the sipe wall face, the oscillation is constant in the tire circumferential direction, an inclination angle in the tire circumferential direction with respect to a normal line direction of the tread surface is configured so as to be smaller at a region on the sipe bottom side than at a region on the tread surface side; and the oscillation in the tire radial direction of the bent portion is configured so as to be greater at a region on the sipe bottom side than at a region on the tread surface side. Note that examples of such a three-dimensional sipe include the technology described in Japanese Patent No. 4316452B.

Additionally, as illustrated in FIG. 3, the three-dimensional sipe 54 has a zigzag form having a narrow amplitude in the tread development view and is disposed inside the shoulder land portion 33. Additionally, of the plurality of sipes 53, 54 disposed in the shoulder land portion 33, the three-dimensional sipe 54 is in a position nearest to the dimple 6. Additionally, the three-dimensional sipe 54, at one end portion, terminates inside the shoulder land portion 33; extends in the tire width direction to become substantially parallel to the lug groove 43; and, at another end portion, connects to the dimple 6. By this, a function of the three-dimensional sipe 54 can be heightened while ensuring a rigidity of the shoulder land portion 33.

Note that the “connection” between the three-dimensional sipe 54 and the dimple 6 includes both a configuration where the three-dimensional sipe 54 and the dimple 6 are communicated and a configuration of making contact at the tread surface. This is described below.

Additionally, in FIG. 4, a sipe depth Hs of the three-dimensional sipe 54 and a groove depth Hr of the lug groove 43 preferably have a relationship where 0.50≦Hs/Hr≦δ0.70. By this, the sipe depth Hs of the three-dimensional sipe 54 is optimized.

The sipe depth Hs is measured as a distance from the tread surface of the shoulder land portion 33 to a maximum depth position of the sipe. Additionally, in a configuration where the sipe has a partial raised bottom portion such as is described below, the sipe depth is measured with such a raised bottom portion excluded.

Additionally, as illustrated in FIG. 5, the three-dimensional sipe 54 has a raised bottom portion 541 in a connecting portion with the dimple 6.

The raised bottom portion 541 of the three-dimensional sipe 54 refers to a portion where in FIG. 5 a sipe depth Hs′ of the three-dimensional sipe 54 becomes 15% or greater and 45% or less than a maximum sipe depth Hs.

The sipe depth Hs′ at the raised bottom portion 541 is measured as a distance in the sipe depth direction from the tire profile to the raised bottom portion 541.

Additionally, in the configuration of FIG. 3 and FIG. 4, as illustrated in FIG. 4, the lug groove 43 of the shoulder land portion 33 has a raised bottom portion 431. Additionally, the raised bottom portion 431 is formed near a merging portion of the lug groove 43 and the circumferential main groove 22.

The raised bottom portion 431 of the lug groove 43 refers to a portion where in FIG. 4 the groove depth of the lug groove 43 becomes 15% or greater and 45% or less than the groove depth Hr.

The groove depth Hr′ at the raised bottom portion 431 is measured as a distance in the groove depth direction from the tire profile to the raised bottom portion 431.

Additionally, in FIG. 4, a length Lr′, of the raised bottom portion 431 of the lug groove 43, in the tire width direction and a ground contact width TW_sh of the shoulder land portion 33 preferably have a relationship where 0.20≦Lr′/TW_sh_≦0.30.

The length Lr′ of the raised bottom portion 431 of the lug groove 43 is measured as a length in the tire width direction. Additionally, in the configuration of FIG. 4, because the lug groove 43 opens to the circumferential main groove 22, the length Lr′ of the raised bottom portion 431 is measured with an opening position of the lug groove 43 to the circumferential main groove 43 as a reference.

The ground contact width TW_sh of the shoulder land portion 33 is measured as a maximum rectilinear distance in the tire width direction of the contact surface between the tire and the flat plate in the configuration in which the tire is assembled on the specified rim, inflated to the specified internal pressure, placed perpendicular to the flat plate in the static state, and loaded with the load corresponding to the specified load.

Additionally, in FIG. 4, the groove depth Hr of the lug groove 43, the groove depth Hr′ of the lug groove 43 at the raised bottom portion 431, and the groove depth Hc of the circumferential main groove 22 preferably have a relationship where 0.85≦Hr/Hc≦1.00 and 0.50≦Hr′/Hc≦0.70. By this, the groove depths Hr, Hr′ of the lug groove 43 are optimized.

Additionally, in FIG. 3, the groove width Wr of the lug groove 43, the groove width Wr′ of the lug groove 43 at the raised bottom portion 431, and the groove width Wc of the circumferential main groove 22 (see FIG. 2) preferably have a relationship where 2.00≦Wr/Wc≦2.50 and 0.70≦Wr′/Wc≦1.25. By this, the groove widths Wr, Wr′ of the lug groove 43 are optimized.

The groove width Wr′ at the raised bottom portion 431 is measured as a maximum value of a distance between left and right groove walls in the groove opening portion in the unloaded state where the tire is mounted to the specified rim and filled to the specified internal pressure.

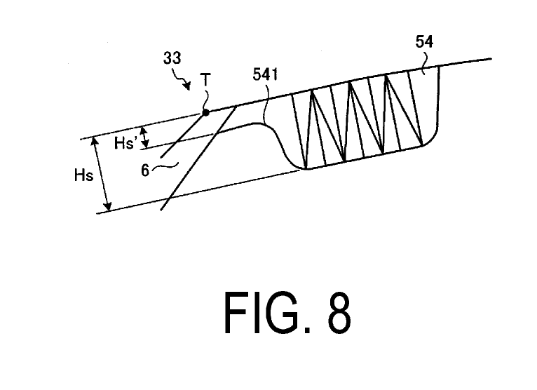

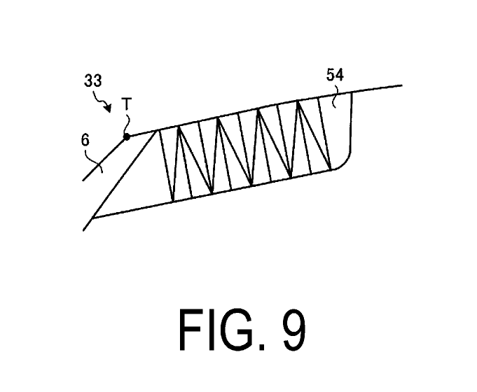

FIG. 8 and FIG. 9 are explanatory views of modified examples of the pneumatic tire illustrated in FIG. 1. These diagrams illustrate modified examples of the three-dimensional sipe illustrated in FIG. 5.

In the configuration of FIG. 5, an end portion of the three-dimensional sipe 54 on the tire-width-direction outer side connects to (contacts) the end portion of the dimple 6 on the tire-width-direction inner side at the tread surface of the shoulder land portion 33. Such a configuration is preferable in that a rigidity of the shoulder land portion 33 at the connecting portion between the three-dimensional sipe 54 and the dimple 6 is ensured.

In contrast thereto, in the configurations according to FIG. 8 and FIG. 9, the three-dimensional sipe 54 is opened and communicated to the dimple 6. Such configurations are preferable in that in a tire vulcanization process, a pullout of a sipe molding blade for molding the three-dimensional sipe 54 becomes favorable, improving a productivity of the tire, and preferable in that a sipe volume of the three-dimensional sipe 54 increases, improving a water absorption of the three-dimensional sipe 54. Additionally, in the configuration of FIG. 8, the three-dimensional sipe 54 has the raised bottom portion 541 at the connecting portion with the dimple 6. By this, the rigidity of the shoulder land portion 33 at the connecting portion between the three-dimensional sipe 54 and the dimple 6 is ensured.

Effect

As described above, this pneumatic tire 1 is provided with the plurality of circumferential main grooves 21, 22 extending in the tire circumferential direction; the plurality of land portions 31 to 33 formed by being defined by these circumferential main grooves 21, 22; and the plurality of lug grooves 41 to 43 disposed in these land portions 31 to 33 (see FIG. 2). Additionally, the shoulder land portion 33 is provided with the dimple 6 for mud discharge that is disposed between the lug grooves 43, 43 adjacent in the tire circumferential direction and extends in the tire width direction without communicating to a lug groove 43 (see FIG. 3 and FIG. 4). Additionally, the distance Dd between the end portion of the dimple 6 on the tire-width-direction inner side and the tire ground contact edge T is in the range of −10 mm≦Dd≦10 mm.

In such a configuration, when traveling on a muddy road, mud is discharged sideways of the tire via the dimple 6 from the tread surface of the shoulder land portion 33. By this, there is an advantage where the mud performance of the tire improves. Additionally, by the end portion of the dimple 6 on the tire-width-direction inner side being disposed near the tire ground contact edge T (within the range of ±10 mm), there is an advantage where the mud performance of the tire improves even more.

Additionally, in this pneumatic tire 1, the surface area Sd of the dimple 6 and the surface area Sb of the region defined by the lug grooves 43 adjacent in the tire circumferential direction have the relationship where 0.10≦Sd/Sb≦0.30 (see FIG. 3). By this, there is an advantage where the surface area Sd of the dimple 6 is optimized. That is, by 0.10≦Sd/Sb, the surface area Sd of the dimple 6 is appropriately ensured, and the mud performance of the tire is ensured. Additionally, by Sd/Sb≦0.30, the rigidity of the shoulder land portion 33 is ensured, collapsing of the shoulder land portion 33 when braking and driving is suppressed, and a snow performance of the tire improves.

Additionally, in this pneumatic tire 1, the end portion of the dimple 6 on the tire-width-direction inner side is on the tire-width-direction inner side of the tire ground contact edge T (see FIG. 3 and FIG. 4). In such a configuration, by the dimple 6 extending to be in the tire ground contact surface, there is an advantage where the mud performance of the tire improves. Additionally, there are advantages where by the dimple 6 the edge component of the shoulder land portion 33 increases and the snow performance of the tire improves.

Additionally, in this pneumatic tire 1, at the end portion of the dimple 6 on the tire-width-direction inner side, the width Wd of the dimple 6 and the interval Wb between the adjacent lug grooves 43, 43 have the relationship where 0.30≦Wd/Wb≦0.55. By this, there is an advantage where the width Wd of the dimple 6 is optimized. That is, by 0.30≦Wd/Wb, the width Wd of the dimple 6 is ensured, and the mud performance of the tire is ensured. Additionally, by Wd/Wb≦0.55, the rigidity of the shoulder land portion 33 is ensured, and the snow performance of the tire when braking and driving improves.

Additionally, in this pneumatic tire 1, the shoulder land portion 33 is provided with the plurality of sipes 53, 54 extending in the tire width direction (see FIG. 3). Additionally, of the plurality of sipes 53, 54, the sipe nearest to the dimple 6 is the three-dimensional sipe 54. In such a configuration, by the mating force of the three-dimensional sipe 54, the rigidity of the shoulder land portion 33 in a vicinity of the dimple 6 is ensured. By this, there is an advantage where the snow performance of the tire when braking and driving improves. Particularly, because the three-dimensional sipe 54 is disposed in the vicinity of the dimple 6, in the tire vulcanization process, the pullout of the sipe molding blade for molding the three-dimensional sipe 54 becomes favorable. By this, there are advantages where breaking of the sipe molding blade and the like are suppressed and the productivity of the tire improves.

Additionally, in this pneumatic tire 1, the sipe depth Hs of the three-dimensional sipe 54 and the groove depth Hr of the lug groove 43 of the shoulder land portion 33 have the relationship where 0.50≦Hs/Hr≦δ0.70 (see FIG. 4). By this, there are advantages where the sipe depth Hs of the three-dimensional sipe 54 is optimized and the function of the three-dimensional sipe 54 is appropriately ensured.

Additionally, in this pneumatic tire 1, the shoulder land portion 33 is provided with the three-dimensional sipe 54 that extends in the tire width direction and connects to the dimple 6 (see FIG. 3). In such a configuration, there are advantages where the edge component of the shoulder land portion 33 increases by the three-dimensional sipe 54 and a snow braking performance of the tire improves. Additionally, there are advantages where by the mating force of the three-dimensional sipe 54 the rigidity of the shoulder land portion 33 in the vicinity of the dimple 6 is ensured and the snow performance of the tire when braking and driving improves.

Additionally, in this pneumatic tire 1, the three-dimensional sipe 54 has the raised bottom portion 541 at the connecting portion with the dimple 6 (see FIG. 4 and FIG. 5). In such a configuration, the raised bottom portion 541 of the three-dimensional sipe 54 reinforces the rigidity of the shoulder land portion 33 at the connecting portion between the three-dimensional sipe 54 and the dimple 6. By this, there are advantages where collapsing of the shoulder land portion 33 when braking and driving is suppressed and the snow performance of the tire improves.

Additionally, in this pneumatic tire 1, the lug groove 43 of the shoulder land portion 33 has the raised bottom portion 431 (see FIG. 4). By this, there are advantages where the rigidity of the shoulder land portion 33 is ensured and the snow performance of the tire improves.

Additionally, in this pneumatic tire 1, the length Lr′, of the raised bottom portion 431 of the lug groove 43, in the tire width direction and the ground contact width TW_sh of the shoulder land portion 33 have the relationship where 0.20≦Lr′/TW_sh≦0.30 (see FIG. 4). By this, there are advantages where the length Lr′ of the raised bottom portion 431 in the tire width direction is ensured and the rigidity of the shoulder land portion 33 is appropriately reinforced.

Additionally, in this pneumatic tire 1, the groove depth Hr of the lug groove 43, the groove depth Hr′ at the raised bottom portion 431 of the lug groove 43, and the groove depth Hc of the circumferential main groove 22 have the relationship where 0.85≦Hr/Hc≦1.00 and 0.50≦Hr′/Hc≦0.70 (see FIG. 4). By this, there are advantages where the groove depths Hr, Hr′ of the lug groove 43 are optimized and the mud performance and the snow performance of the tire improve.

Additionally, in this pneumatic tire 1, the groove width Wr of the lug groove 43, the groove width Wr′ of the lug groove 43 at the raised bottom portion 431, and the groove width Wc of the circumferential main groove 22 (see FIG. 2) have the relationship where 2.00≦Wr/Wc≦2.50 and 0.70≦Wr′/Wc≦1.25 (see FIG. 3). By this, there are advantages where the groove widths Wr, Wr′ of the lug groove 43 are optimized and a wear resistance performance and a wet performance of the tire improve.

Additionally, in this pneumatic tire 1, the shoulder land portion 33 is provided with the notched portion 7 formed in the edge portion of the shoulder land portion 33 on the lug-groove 43 side and the sipe 53 that penetrates the block of the shoulder land portion 33 in the tire circumferential direction and communicates to the notched portion 7 (see FIG. 3). In such a configuration, there are advantages where the edge component of the shoulder land portion 33 increases by the notched portion 7 and the sipe 53 and the snow performance of the tire improves. Particularly, by the notched portion 7 being formed in the edge portion of the shoulder land portion 33 on the lug-groove 43 side and the sipe 53 communicating to this notched portion 7, there are advantages where a drainage action and an edge action improve and a steering stability performance on a wet road surface and the snow performance improve.

### EXAMPLES

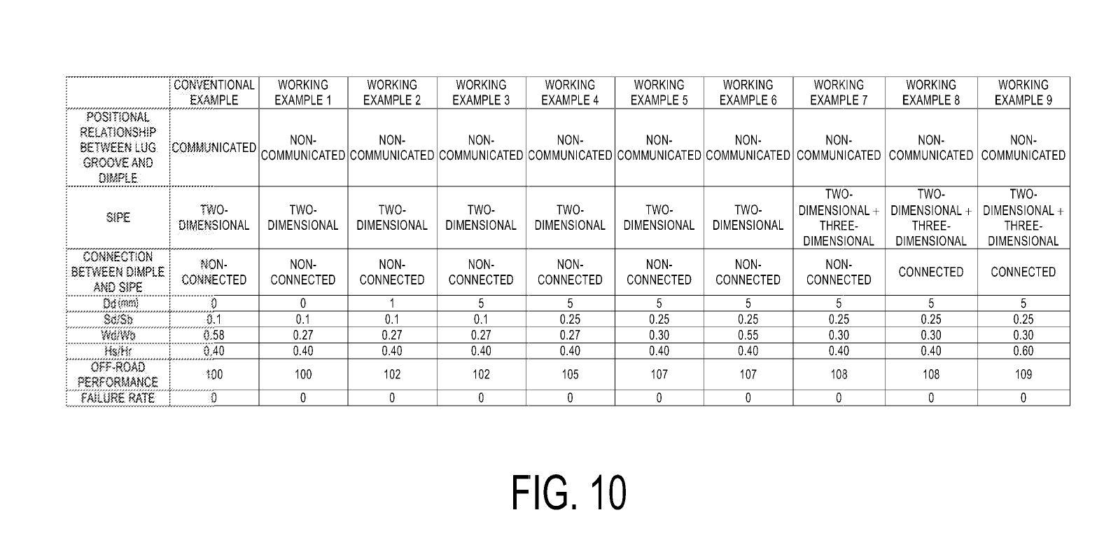

FIG. 10 is a table showing results of performance testing of pneumatic tires according to embodiments of the present technology.

In this performance testing, evaluations relating to (1) the off-road performance (such as the mud performance, the snow performance) and (2) a failure rate were performed for a plurality of types of test tires. Additionally, a test tire of a tire size of 265/70R17 113T is assembled to a rim of a rim size of 17×7.5 J, and an air pressure of 230 kPa and a maximum load of the JATMA standard are imparted to this test tire. Additionally, the test tire is mounted to all wheels of an RV that is a test vehicle.

(1) In the evaluation relating to the off-road performance, the test vehicle travels a test course of a snowy road surface, and a professional test driver makes a sensory evaluation concerning a braking performance and a driving performance. Index evaluation was performed taking the results of the conventional example as a reference (100). Larger numerical values are preferable.

(2) In the evaluation relating to the failure rate, the evaluation is made by observing a loss of tread rubber by the sipe molding blade and an occurrence of cuts for ten tires after vulcanization. This evaluation is a percentage of a number of tires in which a failure arises, and a numerical value of 0 indicates that no failure arises.

Test tires of Working Examples 1 to 9 are provided with the configuration illustrated in FIG. 1 to FIG. 4. However, in the test tires of Working Examples 1 to 6, a two-dimensional sipe is disposed instead of the three-dimensional sipe 54 of the shoulder land portion 33. Meanwhile, in Working Example 7, with the shoulder land portion 33, the three-dimensional sipe 54 does not connect to the dimple 6. Additionally, in each test tire, the groove width Wr of the lug groove 43 of the shoulder land portion 33 is Wr=15 mm, the groove depth Hr is Hr=10 mm, and the land portion width Wb=24 mm. Additionally, the length Ld of the dimple 6 is Ld=21 mm, and the depth Hd is Hd=2.0 mm.

With a test tire of the conventional example, in the test tire of Working Example 1, the dimple 6 communicates to the lug groove 43.

As indicated in the test results, it is understood that with the test tires of Working Examples 1 to 9, the off-road performance of the tire improves and no failure arises during vulcanization.

1. A pneumatic tire, comprising:
a plurality of circumferential main grooves extending in a tire circumferential direction;
a plurality of land portions defined by the circumferential main grooves;
a plurality of lug grooves disposed in the land portions;
when an outermost land portion in a tire width direction of the land portions is referred to as a shoulder land portion,
the shoulder land portion being provided with a dimple for mud discharge that is disposed between lug grooves adjacent in the tire circumferential direction and extends in the tire width direction without communicating to a lug groove; and
a distance Dd between an end portion of the dimple on a tire-width-direction inner side and a tire ground contact edge being in a range of −10 mm≦Dd≦10 mm.

2. The pneumatic tire according to claim 1, wherein a surface area Sd of the dimple and a surface area Sb of a region defined by the lug grooves adjacent in the tire circumferential direction have a relationship where 0.10<Sd/Sb<0.30.

3. The pneumatic tire according to claim 1, wherein the end portion of the dimple on the tire-width-direction inner side is on a tire-width-direction inner side of the tire ground contact edge.

4. The pneumatic tire according to claim 1, wherein at the end portion of the dimple on the tire-width-direction inner side, a width Wd of the dimple and an interval Wb between the adjacent lug grooves have a relationship where 0.30≦Wd/Wb≦0.55.

5. The pneumatic tire according to claim 1, wherein the shoulder land portion is provided with a plurality of sipes extending in the tire width direction and of the plurality of sipes a sipe nearest to the dimple is a three-dimensional sipe.

6. The pneumatic tire according to claim 5, wherein a sipe depth Hs of the three-dimensional sipe and a groove depth Hr of the lug groove of the shoulder land portion have a relationship where 0.50≦Hs/Hr≦0.70.

7. The pneumatic tire according to claim 1, wherein the shoulder land portion is provided with a three-dimensional sipe that extends in the tire width direction and connects to the dimple.

8. The pneumatic tire according to claim 7, wherein the three-dimensional sipe has a raised bottom portion at a connecting portion with the dimple.

9. The pneumatic tire according to claim 1, wherein the lug groove of the shoulder portion has a raised bottom portion.

10. The pneumatic tire according to claim 9, wherein a length Lr′, of the raised bottom portion of the lug groove, in the tire width direction and a contact ground width TW_sh of the shoulder land portion have a relationship re 0.20≦Lr/TW_sh≦0.30.

11. The pneumatic tire according to claim 9, wherein a groove depth Hr of the lug groove, a groove depth Hr′ of the lug groove at the raised bottom portion, and a groove depth Hc of the circumferential main groove have a relationship where 0.85≦Hr/Hc≦1.00 and 0.50≦Hr′/Hc≦0.70.

12. The pneumatic tire according to claim 9, wherein a groove width Wr of the lug groove, a groove width Wr′ of the lug groove at the raised bottom portion, and a groove width We of the circumferential main groove have a relationship where 2.00≦Wr/Wc≦2.50 and 0.70≦Wr′/Wc≦1.25.

13. The pneumatic tire according to claim 1, wherein the shoulder land portion is provided with a notched portion formed in an edge portion of the shoulder land portion on a lug-groove side and a sipe that penetrates a block of the shoulder land portion in the tire circumferential direction and communicates to the notched portion.

14. The pneumatic tire according to claim 1, wherein a length Ld of the dimple in the tire width direction is in a range of 20 mm≦Ld.

15. The pneumatic tire according to claim 1, wherein a depth Hd of the dimple is in a range of 1.0 mm≦Hd≦4.0 mm.
